(19) United States
(12) Patent Application Publication
(10) Pub. No.: US 2013/0036557 A1
(43) Pub. Date: Feb. 14, 2013

(54) FUNCTIONAL LEATHER AND THE METHOD OF PREPARING THEREOF

(71) Applicant: Sam Won Chang, Yongin-si (KR)

(72) Inventor: Sam Won Chang, Yongin-si (KR)

(21) Appl. No.: 13/521,212

(22) PCT Filed: Oct. 17, 2011
(86) PCT No.: PCT/KR11/07702

§ 371 Date: Jul. 9, 2012

(30) Foreign Application Priority Data
Oct. 21, 2010 (KR) 10-2010-0103150

(51) Int. Cl. C14C 99/00

(52) U.S. Cl. 8/94.1 R

(57) ABSTRACT

A manufacturing method of a functional leather comprises a step for preparing a first mixed solution by melting only chitosan, or melting chitosan and chitosan derivative into an acid solution; a step for preparing a second mixed solution containing a material radiating minus ions and the chitosan solution; and a step for depositing a leather into the second mixed solution, and a functional leather manufactured by the above method. This invention provides a functional leather product having strong antibacterial effect and deodorization effect and thereby, it is very helpful for a human being's health.

### BACKGROUND OF THE INVENTION

The present invention is related to a manufacturing method of natural leather and in particular, is related to a manufacturing method of natural leather wherein a radiating material of minus ion is included in a leather, the radiating material of minus ion is fixed by using chitosan and the derivatives thereof and at the same time, metabolism of a human body is galvanized recovery of fatigue is facilitated, and comfortable feeling is secured because of antibacterial and odorless properties in a manufacturing method of natural leather comprising the steps of preparation, tanning, making oily state, dyeing and coating.

To be more specific, the present invention is related to a manufacturing method of a functional leather including a step for preparing a first mixed solution by melting only chitosan, or melting chitosan and chitosan derivative into an acid solution; a step for preparing a second mixed solution containing a material radiating minus ions and the chitosan solution; and a step for depositing a leather into the second mixed solution.

Generally, natural leathers are mainly classified into the natural leathers of animals which are recognized as a high-quality commodity and an artificial leather which are being manufactured recently. As compared with the artificial leather, the natural leather is more excellent in terms of quality, more classier, and durability is superior. But, there is a shortcoming that the price of the natural leather is expensive and the produced quantity is limited.

It is difficult to secure the natural leather of an animal described as above, and the prices of most natural leathers are expensive since the manufacturing procedures thereof is very complicated. Further, it is necessary to perform many processes and prepare chemicals for processing a raw leather for obtaining a leather product, and smell of the chemicals are generated from a surface of a leather because huge amount of chemicals are used, and thereby, the stink gives unpleasant feeling to a consumer.

Further, in addition to the technology to allow functionality to conventional textile fabrics or textile products, a need to provide various kinds of functions to a natural leather product is suggested. However, a natural leather entails a manufacturing process including many complicated steps, and the process requires many items to be considered for applying the functional components efficiently. The Korean Publication Patent No. 2000-17782 discloses a process consisting of a step for adding a mixture obtained by processing a gemstone, elvan and yellow soil into particles and mixing the particles into a dyeing solution for providing radiation of far infrared lights and antibacterial effect to a natural leather, a step for rotating a dyeing target leather existing in a state deposited into the dyeing solution to which the mixture is added, and a step for forcibly sinking the particles into a gap of a coriculum layer and a reticulum layer. Further, Korean Registration No. 489725 discloses a processing method of a natural leather wherein when processing a natural leather, a minus ion ceramic (tourmaline, yellow soil, sericite, amethyst, ore, natural ore, elvan and the like) and an inorganic antibacterial ceramic (a ceramic the surface of which is coated with Ag) are added during a branch process or a neutralization process.

But, there is a drawback that powder of a minus ion or an antibacterial material can be removed from a leather during use or laundering and thus, the functions of the leather may be damaged.

Therefore, the primary object of the present invention is to provide a functional leather so that various kinds of leather products can be manufactured in a large quantity while maintaining high quality and sense of touch of a natural leather, and which are very useful for a human body's health required in a modern society.

### SUMMARY OF THE INVENTION

The applicant of the present invention provides a method for enhancing immunity of a human body, galvanizing metabolism, and facilitating recovery of fatigue, wherein the natural leather is manufactured by depositing a leather into the composition including a white charcoal, seven stone and a radiating material of a minus ion, chitosan and chitosan derivatives in a coating step of a manufacturing process of a natural leather, and thus minus ions are generated from a natural leather.

The present invention provides a manufacturing method of a functional leather including (a) a step for preparing a first mixed solution by melting only chitosan, or melting chitosan and chitosan derivative into an acid solution; (b) a step for preparing a second mixed solution containing a material radiating minus ions and the chitosan solution; and (c) a step for depositing a leather into the second mixed solution, and a functional leather manufactured by the above method.

But, the problems to be solved are not limited to the mentioned ones in the present invention and the other problems which are not mentioned are included and they can be clearly understood by the person in the art from the following descriptions.

In order to accomplish the above-mentioned objects, according to one aspect of the present invention, a manufacturing method of a functional leather including a step for preparing a first mixed solution by melting only chitosan, or melting chitosan and chitosan derivative into an acid solution; a step for preparing a second mixed solution containing a material radiating minus ions and the chitosan solution; and a step for depositing a leather into the second mixed solution is provided.

Further, according to another aspect of the present invention, functional leather manufactured by the above method is provided.

According to the present invention, a functional leather can be provided wherein a soluble chitosan solution that is no harmful and has very excellent sterilization/antibacterial effect, deodorization effect, and a disease prevention effect from bacteria is a main medium, high-polymer powders of minus ions functioning as a vitamin in air which have superior effects such as recovery of fatigue, recovery of physical strength, and prevention of aging are mixed, and the most suitable amount of minus ions can be radiated for a human body. Therefore, a functional leather is provided without changing high-quality and a sense of touch of a natural leather and thereby, the present invention is useful for a health as a functional natural leather having antibacterial effect and deodorization effect.

### BRIEF DESCRIPTION OF DRAWINGS

FIG. 1 is a diagram illustrating a flowchart of a manufacturing method of a functional natural leather according to an embodiment of the present invention.

FIG. 2 is a diagram illustrating manufacturing processes of a functional natural leather according to an embodiment of the present invention.

### DETAILED DESCRIPTION OF THE INVENTION

Below, the embodiments and the examples of the present invention will be explained in detail with referring to the attached drawings, so that the person having a common knowledge in the art to which the present invention belongs can easily implement the present invention.

But, the present invention can be realized as various kinds of examples and is not limited to the embodiments explained in the specification. Further, the portions which do not something to do with the explanation are omitted in the diagrams for explaining the present invention clearly.

Further, when a portion “includes” a component, this means that other components are not excluded, but the other components may be included unless there are other specific descriptions.

“A step for (performing) . . . ” or “a step of . . . ” which is used in the entire specification of the present invention does not mean “a step for . . . ”.

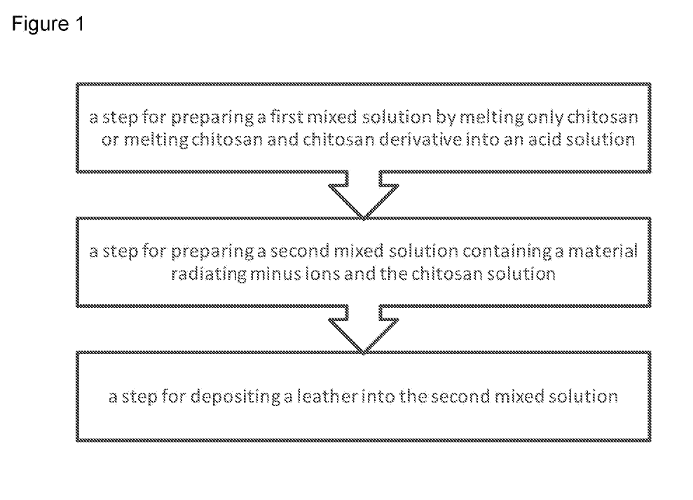

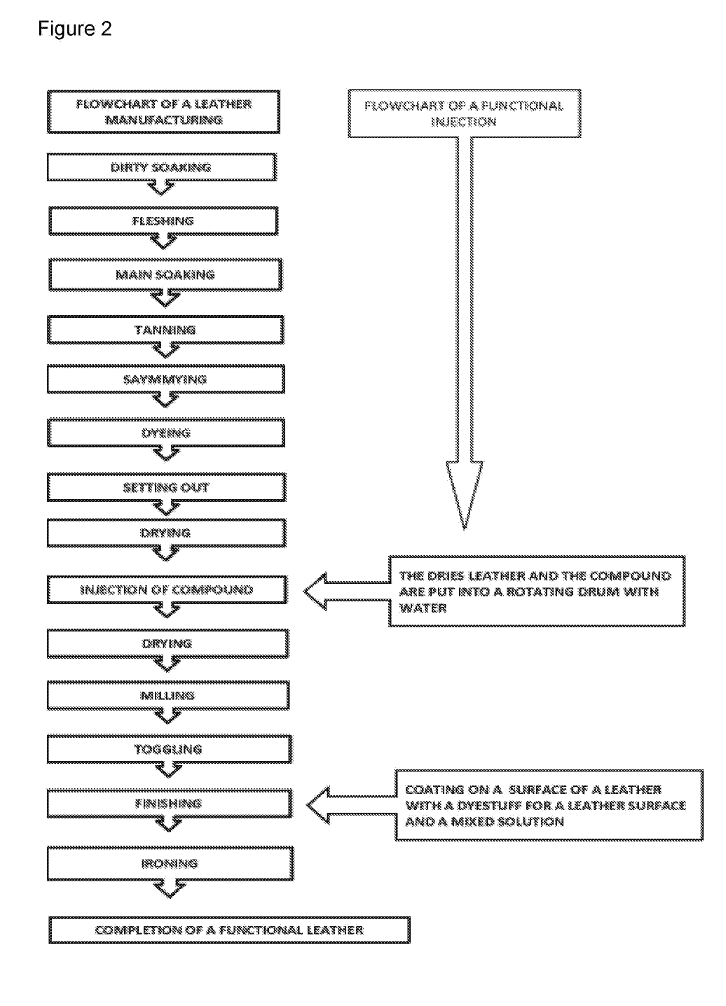

Below, a functional leather and the method of preparing thereof will be explained in detail with referring to FIG. 1 and FIG. 2.

According to one aspect of the present invention, a manufacturing method of a functional leather including a step for preparing a first mixed solution by melting only chitosan into an acid solution, or by melting chitosan and chitosan derivative into an acid solution, a step for preparing a second mixed solution containing a material radiating minus ions and the chitosan solution, and a step for depositing a leather into the second mixed solution is provided.

The processes of the manufacturing method of a functional leather are illustrated in FIG. 1.

Generally, the manufacturing method of a natural leather simply consists of the steps of preparation, tanning, making oily state, dyeing and coating and that is, the method is subject to the steps illustrated in FIG. 2. The present invention is composed of a first deposition performed after a dyeing process for depositing an interior side of a fibroid material of a leather and a surface portion of a leather, and a deposition of a surface portion in a coating process for a complete functional leather.

Chitosan and the chitosan derivative used in the present invention react with enzymes or acids existing on a skin while touching with a human skin, and thus generates the effects such as an antibacterial operation, moisturizing component and immunity improvement. Therefore, the effects that the skin diseases such as allergy, atopicallergy and the like can be improved, and stink of perspiration, static electricity and etc. are prevented can be obtained. Further, keeping warmth is very excellent, and dyeability against the acid dyestuffs also tremendous superior. Chitosan is a polysaccharide high-polymer material formed by coupling numerous monomers in which an acetyl base is removed from chitin, and which is not melted in a water, but are well melted in the organic acids such as lactic acid, citric acid, nitric acid and the lime, or subacid.

In the illustrated embodiment, the content of chitosan or the chitosan derivative of the first mixed solution may range from 3 weight %-20 weight %, but the content is not limited this numeric definition.

In the illustrated embodiment, the material radiating minus ions

may be a minus ion ceramic, but is not limited to this.

The minus ion ceramic means a ceramic generating large amount of minus ions, and consists of native rocks or charcoals. In addition to the minus ion ceramic, a gemstone, germanium, yellow soil, and an inorganic antibacterial ceramic can be employed. The inorganic antibacterial ceramic is a ceramic wherein a surface is coated with a silver Ag, and in case of a ceramic coated with Ag, antibacterial property and anti-mildewy effect can be enhanced. In particular, there are many cases that the zeolite coated with Ag is employed.

In the illustrated embodiment, the minus ion ceramic may be anyone selected from a white coal, seven stone, tourmaline, yellow soil, sericite, amethyst, ore, natural ore and elvan or compound thereof, but is not limited to these ores.

Besides them, muddy coal, kiyoseki, obsidian, Na₂CO₃, white charcoal or binchotan, Ryuoh stone, tennen stone, lava may be used, but the minus ion ceramic is not limited to these ores.

The white coal is a coal acquired by heating an oak tree at a high temperature above 1,000° C., and contains carbon of 90%, and water of 10%, and consists of tiny amount of calcium oxide. The acidity of a charcoal is a weak alkali ranging from pH 8 to pH 9, and consists of many porous materals in which an interior space of 1 g of the charcoal becomes approximately 1,000 pyung, and contains approximately 230 kinds of minerals. The effects of the white coal are as follows. Purification operation of an air is executed by generating minus ions in itself, metabolism of a human body is facilitated by emitting far infrared lights, and smell and humidity are absorbed by the porous materials. Further, preservation against decay and filtering effect are exceedingly excellent.

The seven stone is an ore material having more than seven colors and emits strong energy of 250 times as compared with a gemstone. In addition, it radiates energy of 36 unique properties and consists of granite, schist rock, gneiss, limestone, quartzite, shale, andesite and the like.

In the illustrated embodiment, a particle diameter of the material radiating minus ions ranges from 0.1 μm to 100 μm, but the diameter is not limited to this range.

In the illustrated embodiment, if the particle size of the material radiating minus ions is below 0.7 μm, it affects the cost of a product and if the particle size of the material radiating minus ions exceeds 50 μm, the attachment force is reduced and the coating surface becomes rough and dull. That is, the physical properties are influenced. In particular, a problem that the quality of a natural leather is deteriorated. Therefore, it is very important to select a suitable particle diameter.

In the illustrated embodiment, the acid solution may be one using polyvalent acid, but it is not limited to this.

In the illustrated embodiment, the polyvalent acid may be anyone selected from sulfuric acid, phosphoric acid, citric acid, tartaric acid, adipic acid, oxalic acid, succinic acid, sebacic acid, and maleic acid, or a compound thereof, but it is not limited to these acids.

When fixing the material radiating minus ions to a leather by mixing the material radiating minus ions with the solutions of chitosan and the chitosan derivative, and then, preparing the chitosan solution, an acid used in a step for dissolving chitosan and the chitosan derivative may be organic acid or an inorganic acid. But, it is preferable to use a polyvalent acid in order to fix the material radiating minus ions by using chitosan. In the present invention, it is preferable to use phosphoric acid, citric acid, and tartaric acid which are stable for a human body and can be easily fixed as a polyvalent acid.

In the illustrated embodiment, a molecular weight of chitosan may range from 15,000 g/mol to 1,000,000 g/mol, but is not limited to this range.

Any one of the above chitosan may be used, but it is suitable to use of chitosan having a molecular weight ranging from 15,000 g/mol to 1,000,000 g/mol, and it is preferable to use chitosan having molecular weight ranging from 15,000 g/mol to 200,000 g/mol. More preferably, it is more efficient to use chitosan having a molecular weight ranging from 30,000 g/mol to 100,000 g/mol. The main reason of it is that chitosan has superior antibacterial effect and can easily fix a minus ion material.

In the illustrated embodiment, the chitosan derivative may be a fourth grade amine chitosan denoted by the chemical equation 1, but it is not limited to this.

It is preferable that the chitosan derivative uses the fourth grade amine chitosan for improving antibacterial function and anti-mildewy effect, and uses the molecular weight same as that of chitosan. The reason of it is that an antibacterial effect is very excellent and a minus ion material can be easily fixed. Only chitosan may be used, but it is possible to mix a fourth grade amine chitosan and chitosan and use the mixed compound.

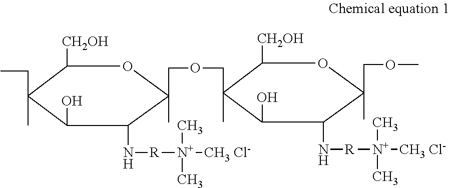

<N-2,3-dihydroxypropyl trimetyl ammonium chloride>

According to another aspect of the present invention, a functional leather manufactured by the above method is provided.

The functional leather has the emission amount of minus ions ranging from 700 ions/cc to 2,000 ions/cc and has also powerful antibacterial function and an minus ion effect. The functional leather may be used for diverse purposes such as the leather gloves, leather shoes, a belt, a back support of a seat, a seat and the like, but it is not limited to the purposes.

### Embodiment 1

Manufacturing of a Natural Leather Containing Functinality

A mixed solution of an amine chitosan (a first mixed solution) is prepared by dissolving 5% of each of chitosan having a molecular weight ranging from 15,000 g/mol to 1,000,000 g/mol, and the chitosan derivative into a kind of a polyvalent acid, that is, 10% of an organic acid solution. Next, a particle diameter of a minus ion powder radiating minus ions is pulverized into 0.1 μm-100 μm and subsequently, 5% of the pulverized minus ion powder is sufficiently churned together with the first mixed solution at a room temperature under a rotation condition (500 rpm), and thereby a chitosan mixed solution (a second mixed solution) radiating minus ions is prepared.

In a general manufacturing process of a leather, a dirty soaking for eliminating impurities existing in a raw hide, bacteria, and salts is performed as a preparatory step and then, a fleshing step for removing oils is executed. Then, the preparatory processes such as a main soaking step and a liming step for converting the raw hide into wet blue are executed.

After these preparatory processes, a tanning process called as dressing skin and converting an animal skin (skin, hide) into a leather is executed.

The leather subject to the tanning process and the preparatory processes is sunk into a dye pre-processing agent containing a mineral tannin (for example: Ecotan Cr), water is extracted, the leather is soaked into a solution of dyestuffs and a dyeing agent, dyeing is performed, the dyed leather is dehydrated, and the leather is post-processed by a botanical tannin agent and a packing agent. Then, after a first vacuum dry process, the leather is subject to a deposition process of the first mixed solution under the state that the humidity content in a leather is minimized by a second heated-air drying process. Subsequently, the dried leather and the water are put at a ratio of 5:5 in a rotating drum, a compound containing the prepared chitosan is thrown into the rotating drum twice by below 10% of a total weight while setting pause of 30 minutes between injections at a rotation condition (15 rpm), the functional compound is injected into a fibroid material of a leather by the rotating drum for about 180 minutes, a dehydrating process and a natural dry process are performed once again and thereby, a stable fixing process of a leather is completed primarily.

Next, a coating process is performed as a last one, and the coating process consists of a first base coating process for softening sense of touch of a raw hide of a leather, a second base coating for plastering chemicals on the leather for securing the properties required for a leather, a reworking process for additionally processing the portions which are not processes sufficiently in the first and the second coating processes, and a top process for preventing colors not to be stained. In the present invention, 10-15% of the second mixed solution is diluted in a top coating agent and then, a coating is performed on a surface portion of a raw hide once again.

After the coating process, ironing is executed by a heat iron at a high temperature and mighty pressure during a heat iron process, and thus complete attachment is realized in the fibroid material of a leather and on a surface. Therefore, a functional leather having a strong antibacterial function and a minus ion effect to enable quality and sense of touch of a natural leather to be maintained as they are, and which can be used widely is completed.

### Embodiment 2

### Antibacterial Test

In connection with the natural leather processes according to the embodiment 1, the antibacterial test was conducted by the Korea Far Infrared Association and the final results are indicated in Table 1 as below.

1) test method: KS K 0693-2006

2) used strain: Staphylococcus aureus (ATCC 6538), Klebsiella pneumonia (ATTC 4352)

TABLE 1

| | | | | reduction |
|---|---|---|---|---|
| | | Initial | after | rate of |
| | | Concentration | 18 hours | bacteria |
| TEST ITEMS | SAMPLE | (CFU/ml) | (CFU/ml) | (%) |
| Antibacterial | Control | 3.8 × 101 | 2.2 × 106 | |
| Test for | functional | | <2.0 × 102 | 99.9 |
| Staphylococcus | leather | | | |
| aureus | (UNIVERSA | | | |
| | PONDERA) | | | |
| Antibacterial | Control | 3.8 × 101 | 1.6 × 106 | |
| Test for | functional | | <2.0 × 102 | 99.9 |
| Klebsiella | leather | | | |
| pneumonia | (UNIVERSA | | | |
| | PONDERA) | | | |

1) Control KS K 0905 Standard adjacent fabrics for color fastness test (Cotton)

2) The number of bacteria in a petri dish was detected by multiplication of dilution rate.

1) Test method: KS K 0693: 2006

2) Name of Used bacteria:

Staphylococcus aureus ATCC 6538

Klebsiella pneumonia ATTC 4352

3) Refer to the Enclosed (2-1, 2-2)

4) Usage: quality management

### Minus Ion Emission Test

In connection with the natural leather processes according to the embodiment 1, the antibacterial test was conducted by the Korea Institute of Construction Materials and the effects of minus ions are indicated in Table 2 as below.

TABLE 2

| | Test item |
|---|---|
| Sample | Minus Ions (ion/cc) |
| (UNIVERSA PONDERA) | 1,738 |

1) Test method: KFIA-F1-1042

2) Sample size: 100×150 mm

3) The above experiment was conducted by 10N analyzer under the atmosphere conditions of a temperature of 20° C. a humidity of 20%, the number of minus ions of 102/cc. The minus ions were measured from the sample, and the results are denoted by the number of the minus ions per unit volume.

4) Usage: quality management.

The primary object of the present invention is to manufacture a functional leather product which is useful for a human being's health and thus is much required in a modern society, and to enable various kinds of leather products to be manufactured on a large scale while maintaining quality and sense of touch of a natural leather as they are.

According to the present invention, a water-soluble chitosan solution which is not harmful to a human body, and has sterilization.antibacterial function, deoderization function and remarkable prevention of a disease is used as a main medium. Further, high-polymerized powders of minus ions which exist as a vitamin in the air and have the superior effects such as prevention of fatigue, recovery of physical strength and prevention of aging are mixed. Thus, it is possible to provide a functional leather which can discharge the most adequate amount of minus ions for a human body. Therefore, a functional leather is provided without changing sense of touch and quality of a natural leather and thereby, a functional leather having a powerful antibacterial function and deoderization function remarkably contributes to a human being's health.

Further, the functional leather has the emission amount of minus ions ranging from 700 ions/cc to 2,000 ions/cc which are very suitable for a human body and thus, has powerful antibacterial function and a minus ion effect. The functional leather may be used for diverse purposes such as leather gloves, leather shoes, leather clothes, belts, a back support for a seat, seats and the like, but is not limited to these purposes.

1. A manufacturing method of a functional leather comprising:
a step for preparing a first mixed solution by melting only chitosan, or melting chitosan and chitosan derivative into an acid solution;
a step for preparing a second mixed solution containing a material radiating minus ions and the chitosan solution; and
a step for depositing a leather into the second mixed solution.

2. The manufacturing method of a functional leather according to the claim 1, wherein the content of chitosan or the chitosan derivative of the first mixed solution may range from 3 weight %-20 weight %.

3. The manufacturing method of a functional leather according to the claim 1, wherein the material radiating minus ions is a minus ion ceramic.

4. The manufacturing method of a functional leather according to the claim 3, wherein the minus ion ceramic may be anyone selected from a white coal, a seven stone, tourmaline, yellow soil, sericite, amethyst, ore, natural ore and elvan or compound thereof.

5. The manufacturing method of a functional leather according to the claim 1, wherein a particle diameter of the material radiating minus ions ranges from 0.1 μm to 100 μm.

6. The manufacturing method of a functional leather according to the claim 1, wherein the acid solution may be one using polyvalent acid.

7. The manufacturing method of a functional leather according to the claim 6, wherein the polyvalent acid may be anyone selected from sulfuric acid, phosphoric acid, citric acid, tartaric acid, adipic axid, oxalic acid, succinic acid, sebacic axid, and maleic acid, or a compound thereof.

8. The manufacturing method of a functional leather according to the claim 1, wherein a molecular weight of chitosan ranges from 15,000 g/mol to 1,000,000 g/mol.

9. The manufacturing method of a functional leather according to the claim 1, wherein the chitosan derivative may be a fourth grade amine chitosan denoted by following chemical equation 1. 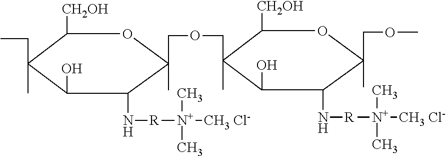
<N-2,3-dihydroxypropyl trimetyl ammonium chloride>

10. A functional leather manufactured by the method of claim 1.

11. A functional leather manufactured by the method of claim 2.

12. A functional leather manufactured by the method of claim 3.

13. A functional leather manufactured by the method of claim 4.

14. A functional leather manufactured by the method of claim 5.

15. A functional leather manufactured by the method of claim 6.

16. A functional leather manufactured by the method of claim 7.

17. A functional leather manufactured by the method of claim 8.
